(19) United States
(12) Patent Application Publication
(10) Pub. No.: US 2014/0185591 A1
(43) Pub. Date: Jul. 3, 2014

(54) POWER CONTROL WITH DYNAMIC TIMING UPDATE

(71) Applicant: QUALCOMM Incorporated, (US)

(72) Inventors: Nate Chizgi, Sunnyvale, CA (US); Wei Zhang, Santa Clara, CA (US); Ravi Gopalan, San Diego, CA (US); Nitin Kasturi, Saratoga, CA (US)

(73) Assignee: QUALCOMM Incorporated, San Diego, CA (US)

(21) Appl. No.: 13/774,280

(22) Filed: Feb. 22, 2013

Related U.S. Application Data
(60) Provisional application No. 61/621,391, filed on Apr. 6, 2012.

(51) Int. Cl. H04W 52/04

(52) U.S. Cl. CPC H04W 52/04
USPC 370/336

(57) ABSTRACT

Methods and apparatuses for wireless communication include determining whether to move a receive window by more than a change in an uplink transmit timing of a user equipment (UE). The methods and apparatuses further include moving the receive window by an amount larger than the change in the uplink transmit timing when a determination is made to move the receive window by more than the change in the uplink transmit timing. Moreover, the methods and apparatuses include identifying at least one cell with receive time within the receive window at the UE.

### CLAIM OF PRIORITY UNDER 35 U.S.C. §119

The present application for patent claims priority to Provisional Application No. 61/621,391 entitled “Power Control With Dynamic Timing Update” filed Apr. 6, 2012, and assigned to the assignee hereof and hereby expressly incorporated by reference herein.

### BACKGROUND

1. Field

Aspects of the present disclosure relate generally to techniques for performing power control in wireless communication systems.

2. Background

In a wireless communication system, a user equipment (UE) such as a cellular phone may communicate with one or more cells via transmissions on the downlink and uplink. A “cell” can refer to a coverage area of a base station and/or a base station subsystem serving the coverage area. The downlink (or forward link) refers to a communication link from a cell/base station to a UE, and the uplink (or reverse link) refers to a communication link from the UE to the cell/base station.

A wireless communication system may include a number of cells that can support communication for a number of UEs. In a Code Division Multiple Access (CDMA) system, a cell can transmit data to multiple UEs simultaneously. The total transmit power available at the cell determines the downlink capacity of the cell. A portion of the total available transmit power of the cell may be allocated to each UE served by the cell such that the aggregate transmit power allocated to all UEs served by the cell is less than or equal to the total available transmit power.

To maximize downlink capacity, downlink power control may be performed for each UE. Downlink power control for each UE may attempt to adjust the transmit power of a downlink transmission to the UE such that good performance can be achieved for the UE while minimizing the amount of transmit power used for the UE.

A UE may be served by one or more cells on the downlink. To support downlink power control, the UE may estimate a received signal quality of each cell serving the UE. However, the signal quality estimation may be adversely impacted due to sudden change in cell timing.

### SUMMARY

In one aspect, a method for wireless communication includes determining whether to move a receive window by more than a change in an uplink transmit timing of a user equipment (UE). Moreover, the method includes moving the receive window by an amount larger than the change in the uplink transmit timing when a determination is made to move the receive window by more than the change in the uplink transmit timing. Also, the method includes identifying at least one cell with receive time within the receive window at the UE.

In another aspect, an apparatus for wireless communication includes means for determining whether to move a receive window by more than a change in an uplink transmit timing of a user equipment (UE). The apparatus further includes means for moving the receive window by an amount larger than the change in the uplink transmit timing when a determination is made to move the receive window by more than the change in the uplink transmit timing. Also the apparatus includes means for identifying at least one cell with receive time within the receive window at the UE.

Another aspect of the disclosure provides an apparatus for wireless communication comprising at least one processor configured to determine whether to move a receive window by more than a change in an uplink transmit timing of a user equipment (UE). Moreover, the at least one processor is configured to move the receive window by an amount larger than the change in the uplink transmit timing when a determination is made to move the receive window by more than the change in the uplink transmit timing. Also, the at least one processor is configured to identify at least one cell with receive time within the receive window at the UE.

Additional aspects provide a computer program product comprising a computer-readable medium including at least one instruction for causing a processor to determine whether to move a receive window by more than a change in an uplink transmit timing of a user equipment (UE). Further, the at least one instruction for causing the processor to move the receive window by an amount larger than the change in the uplink transmit timing when a determination is made to move the receive window by more than the change in the uplink transmit timing. Moreover, the at least one instruction for causing the processor to identify at least one cell with receive time within the receive window at the UE.

These and other aspects of the invention will become more fully understood upon a review of the detailed description, which follows.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a schematic diagram of an example of a communication network including an aspect of the user equipment described herein;

FIG. 2A is a conceptual diagram illustrating a format of the downlink DPCH in a given technology type;

FIG. 2B is a conceptual diagram illustrating a format for a common pilot channel in a given technology type;

FIG. 3 is a schematic diagram illustrating a downlink power control mechanism;

FIG. 4 is a conceptual diagram of a receive timing and transmit timing at a user equipment for a reference cell;

FIG. 5 is a conceptual diagram of an uplink and downlink timing scenario, according to the aspects described herein;

FIG. 6 is a schematic diagram of a communication network including of a user equipment that may perform power control with dynamic timing updates;

FIG. 7 is a schematic diagram of an aspect of the receive window adjustment component of FIG. 1;

FIG. 8 is a flowchart of an aspect of a method of wireless communication, e.g., according to FIG. 6;

FIG. 9 is a block diagram conceptually illustrating an example of a Node B in communication with a user equipment in a telecommunications system, e.g., the user equipment of FIG. 6; and

FIG. 10 is schematic diagram of an example rake receiver, e.g., according to the aspects described herein.

### DETAILED DESCRIPTION

Techniques for performing power control with dynamic timing update are disclosed herein. These techniques may be used for various wireless communication systems such as Code Division Multiple Access (CDMA) systems, Time Division Multiple Access (TDMA) systems, Frequency Division Multiple Access (FDMA) systems, Orthogonal FDMA (OFDMA) systems, Single-Carrier FDMA (SC-FDMA) systems, etc. The terms “system” and “network” are often used interchangeably. A CDMA system may implement a radio technology such as Universal Terrestrial Radio Access (UTRA), cdma2000, etc. UTRA includes Wideband CDMA (WCDMA), Time Division Synchronous CDMA (TD-SCDMA), and other variants of CDMA. cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi and Wi-Fi Direct), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless systems and radio technologies mentioned above as well as other wireless systems and radio technologies. For clarity, certain aspects of the techniques are described below for WCDMA, and WCDMA terminology is used in much of the description below.

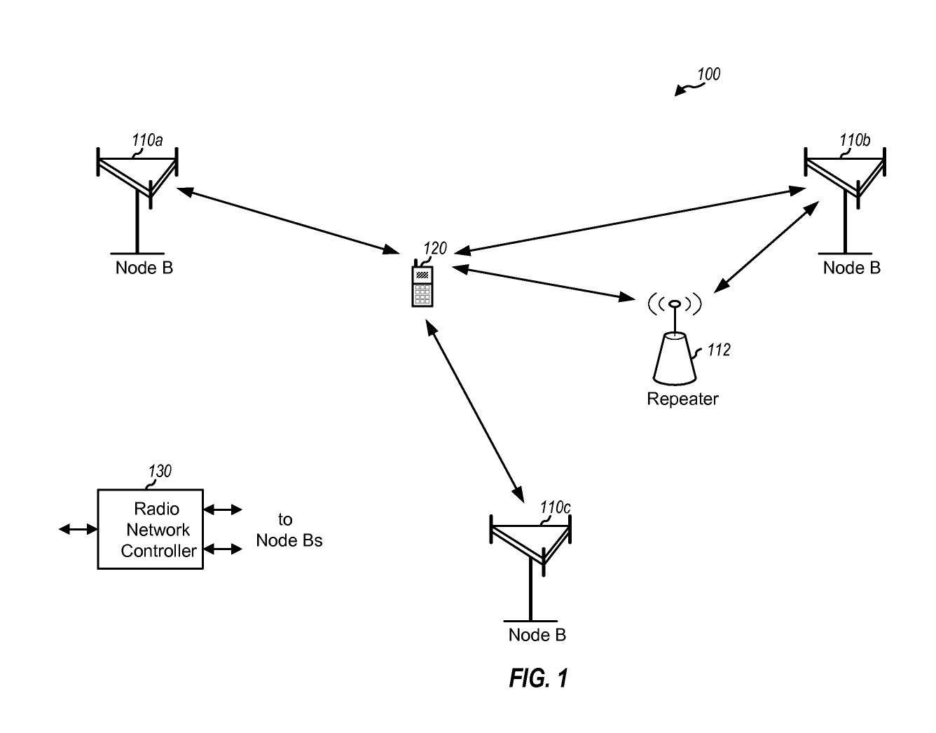

FIG. 1 shows a wireless communication system 100, which may be a WCDMA system or some other wireless system. System 100 may include a number of Node Bs and other network entities. For simplicity, only three Node Bs 110a, 110b and 110c are shown in FIG. 1. A Node B may be an entity that communicates with the UEs (e.g., UE 120) and may also be referred to as a base station, a base transceiver subsystem (BTS), an evolved Node B (eNB), an access point, etc. Each Node B may provide communication coverage for a particular geographic area and may support communication for UEs located within the coverage area. To improve system capacity, the overall coverage area of a Node B may be partitioned into multiple (e.g., three) smaller areas. Each smaller area may be served by a respective Node B subsystem. In 3GPP, the term “cell” can refer to a coverage area of a Node B and/or a Node B subsystem serving this coverage area. In 3GPP2, the term “sector” can refer to a coverage area of a base station and/or a base station subsystem serving this coverage area. For clarity, the concept of “cell” in 3GPP is used in the description herein.

UEs (e.g., UE 120) may be dispersed throughout the system, and each UE may be stationary or mobile. For simplicity, only one UE 120 is shown in FIG. 1. A UE may also be referred to as a mobile station, a terminal, an access terminal, a subscriber unit, a station, etc. A UE may be a cellular phone, a smartphone, a tablet, a wireless communication device, a personal digital assistant (PDA), a wireless modem, a handheld device, a laptop computer, a cordless phone, a wireless local loop (WLL) station, a netbook, a smartbook, etc. A UE may communicate with a cell/Node B via the downlink and uplink.

The system may include repeaters. For simplicity, only one repeater 112 is shown in FIG. 1. A repeater may be an entity that receives, amplifies, and forwards a signal. In the example shown in FIG. 1, repeater 112 may receive a downlink signal from Node B 110b and forward the downlink signal to UE 120.

A radio network controller (RNC) 130 may couple to a set of Node Bs and other network entities. RNC 130 may provide coordination and control for the Node Bs coupled to it. RNC 130 may also be referred to as a base station controller (BSC), a mobile switching center (MSC), etc.

WCDMA defines a channel structure capable of supporting multiple UEs concurrently and efficiently transmitting various types of data. In WCDMA, data to be transmitted on the downlink to a particular UE is processed as one or more transport channels at higher layers. The transport channels support concurrent transmission of different types of services such as voice, video, packet data, etc. The transport channels are mapped to one or more physical channels, which are assigned to the UE for a communication session (e.g., a call). In WCDMA, a downlink dedicated physical channel (DPCH) or fractional DPCH (F-DPCH) may be assigned to the UE for the duration of a communication session. The downlink DPCH carries transport channel data and control data in a time division multiplexed (TDM) manner. The downlink DPCH is characterized by the possibility of fast data rate change, fast power control, and inherent addressing to a specific UE.

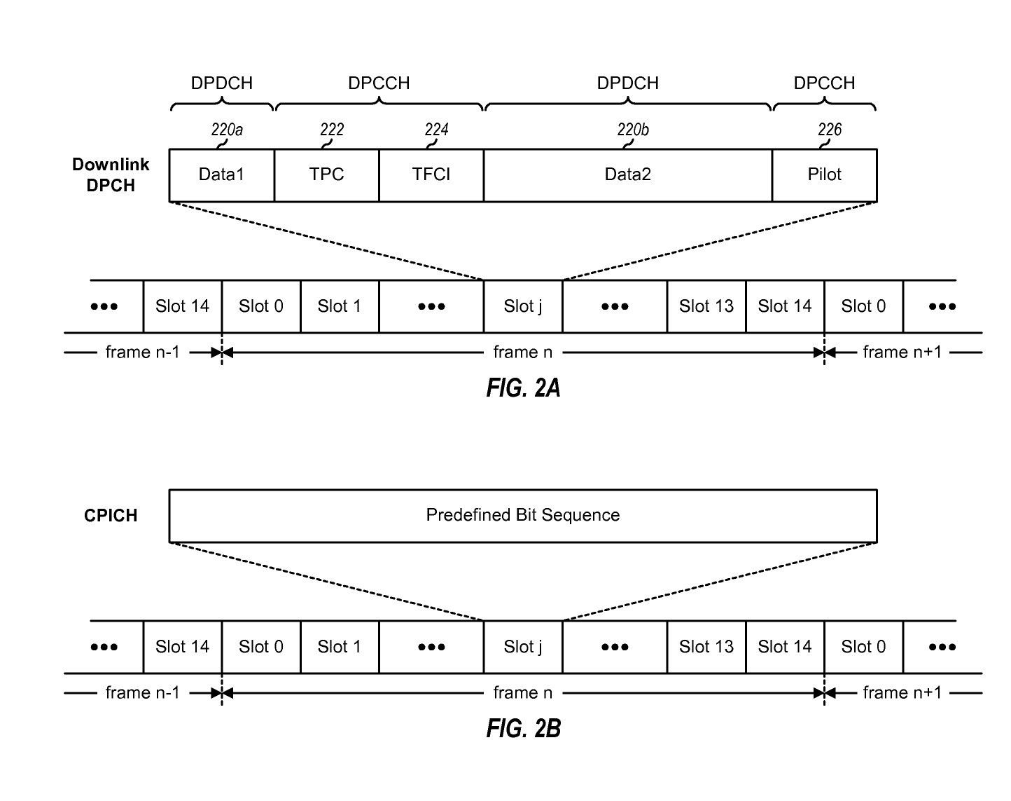

FIG. 2A shows the format of the downlink DPCH in WCDMA. Data may be transmitted on the downlink DPCH in radio frames. Each radio frame may be transmitted over a 10 milli-seconds (ms) frame, which may be divided into 15 slots. Each slot may be further partitioned into multiple fields for different types of data.

As shown in FIG. 2A, for the downlink DPCH, each slot may include data fields 220a and 220b (Data1 and Data2), a transmit power control (TPC) field 222, a transport format combination indicator (TFCI) field 224, and a pilot field 226. Data fields 220a and 220b may carry traffic data. TPC field 222 may carry a TPC command for uplink power control. TFCI field 224 may carry transport format information for the downlink DPCH. Pilot field 226 may carry a dedicated pilot for a UE. The duration of each field may be determined by a slot format used for the downlink DPCH.

As shown in FIG. 2A, the downlink DPCH is a multiplex of a downlink dedicated physical data channel (DPDCH) and a downlink dedicated physical control channel (DPCCH). Traffic data may be sent on the DPDCH, and control data/signaling information may be sent on the DPCCH.

FIG. 2B shows the format for a common pilot channel (CPICH) in WCDMA. The CPICH is a fixed rate (30 kbps) downlink physical channel that carries a predefined bit sequence. The CPICH is transmitted at a fixed power level. The CPICH may be used by UEs for coherent demodulation, received signal quality estimation, timing adjustment, etc.

As discussed above, downlink power control may be performed for a UE in order to ensure good performance for the UE while minimizing the amount of transmit power used for the UE. Downlink power control may be performed between the UE and one or more cells serving the UE and included in an active set of the UE.

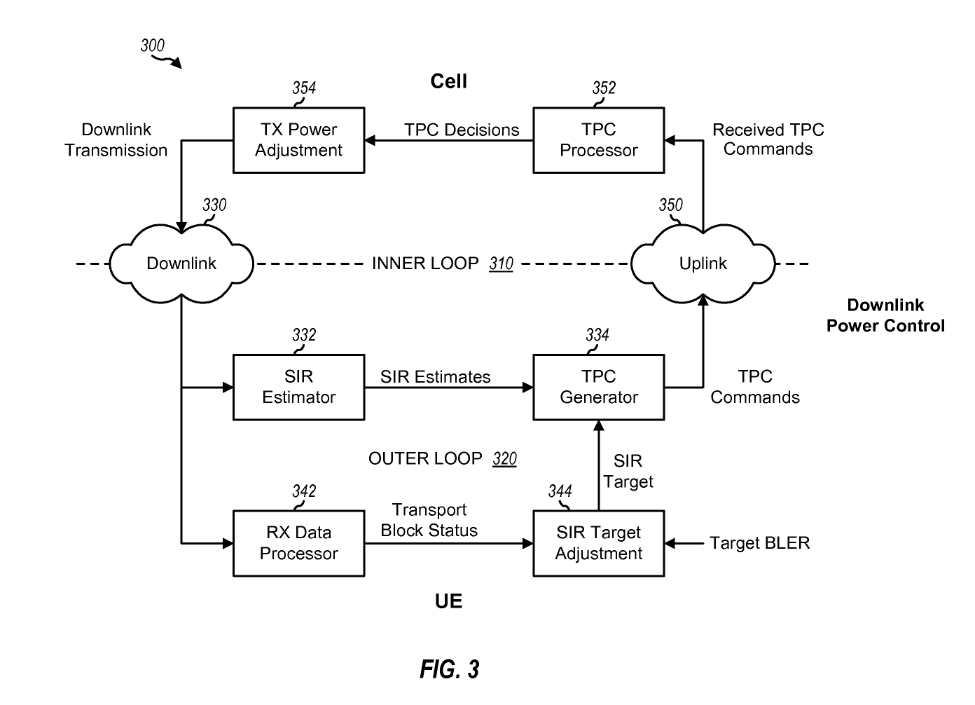

FIG. 3 shows a power control mechanism 300 that may be used for downlink power control in WCDMA. Power control mechanism 300 includes an inner loop 310 and an outer loop 320 that operates between a UE and one or more cells. For simplicity, only one cell is shown in FIG. 3.

Inner loop 310 attempts to maintain a received signal-to-interference ratio (SIR) of a downlink transmission from the cell, as measured at the UE, as close as possible to a SIR target. For inner loop 310, a SIR estimator 332 may estimate the received SIR of the downlink transmission (e.g., based on the dedicated pilot in the downlink DPCH shown in FIG. 2A) and provide a SIR estimate to a TPC generator 334. TPC generator 334 may also receive the SIR target from an adjustment unit 344, compare the SIR estimate against the SIR target, and generate a TPC command based on the result of the comparison. The TPC command may be (i) an UP command to direct an increase in transmit power for the downlink transmission to the UE if the SIR estimate is less than the SIR target or (ii) a DOWN command to direct a decrease in transmit power for the downlink transmission if the SIR estimate is greater than the SIR target. One TPC command may be generated in each slot and may be sent on the uplink (cloud 350) to the cell.

The cell may process an uplink transmission from the UE and may obtain a received TPC command in each slot. A received TPC command is an estimate of a TPC command sent by the UE. A TPC processor 352 may detect each received TPC command and provide a TPC decision, which may indicate whether an UP command or a DOWN command was detected. A unit 354 may adjust the transmit power of the downlink transmission to the UE based on the TPC decision. In WCDMA, TPC commands may be sent as often as 1500 times per second, thus providing a relatively fast response time for inner loop 310.

Due to path loss and fading on the downlink (cloud 330), which may vary over time and especially for a mobile UE, the received SIR at the UE may continually fluctuate. Inner loop 310 attempts to maintain the received SIR at or near the SIR target in the presence of changes in the downlink.

Outer loop 320 continually adjusts the SIR target such that a target block error rate (BLER) can be achieved for the downlink transmission to the UE. A receive (RX) data processor 342 may process the downlink transmission and decode transport blocks sent in the downlink transmission to the UE. RX data processor 342 may further check each decoded transport block to determine whether it was decoded correctly (good) or in error (erased) or not transmitted at all (DTX). Processor 342 may first determine whether a transport block is good or not good based on a cyclic redundancy check (CRC) value included in the transport block. If the transport block is not good, then processor 342 may next determine whether the transport block is erased or DTX based on a received SIR or a received energy of the transport block. RX data processor 342 may provide the status (e.g., good, bad, or DTX) of each decoded transport block received in the downlink transmission.

Adjustment unit 444 may receive the transport block status from processor 342 and the target BLER and may determine the SIR target. If a transport block is decoded correctly, then the received SIR at the UE may be higher than necessary, and the SIR target may be reduced by a small down step. Conversely, if a transport block is decoded in error, then the received SIR at the UE may be lower than necessary, and the SIR target may be increased by a large up step. The SIR target may be maintained at the same level if no transport blocks (or DTX blocks) have been received. The ratio of the up step to the down step may be selected based on the target BLER. The magnitude of the up step and down step may be selected based on a desired rate of convergence for the outer loop.

The cell may set the target BLER for the downlink DPCH and may signal the target BLER to the UE. The UE may set the SIR target based on the target BLER when the downlink DPCH is set up or reconfigured. The inner loop may help the SIR estimate at the UE to converge to SIR target by generating TPC commands for the cell to increase or decrease the transmit power of the downlink DPCH. The outer loop may adjust the SIR target based on the status of transport blocks received on the downlink DPCH to achieve the target BLER.

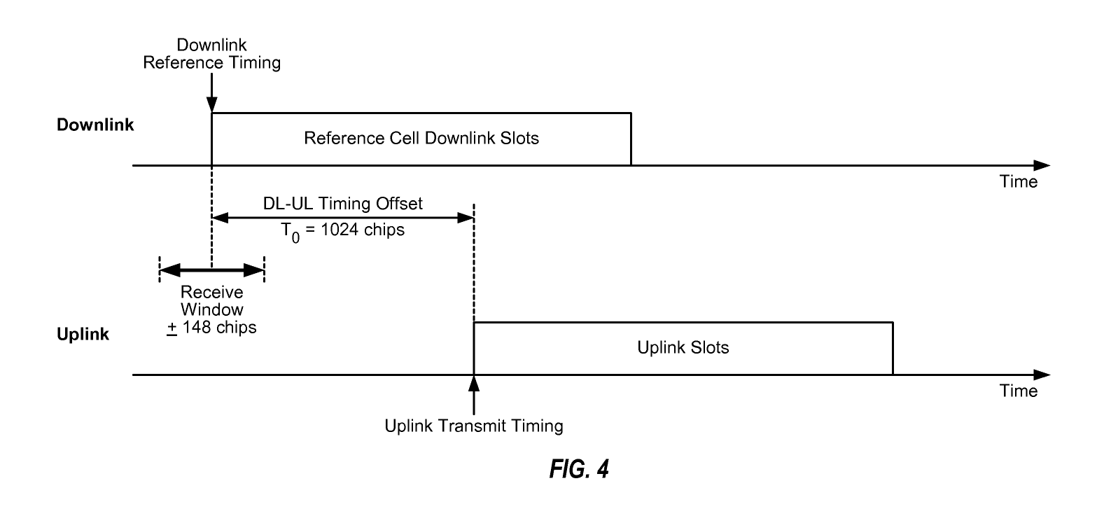

FIG. 4 shows receive timing and transmit timing at the UE for a reference cell, which may be a serving cell of the UE. The UE may receive the downlink DPCH or F-DPCH from the reference cell. A downlink reference timing may be defined based on the time of the first detected path of the reference cell at the UE for the start of a DPCH or F-DPCH frame. An uplink transmit timing may be defined based on a specified downlink-uplink timing offset from the downlink reference timing. The downlink-uplink timing offset may be denoted as To and may be equal to 1024 chips in WCDMA, with each chip having a duration of 1/3,840,000 seconds. A receive window may be defined to be centered at T₀ chips prior to the uplink transmit timing and to have a width of 296 chips. The receive window may thus be given as T₀±148 chips.

FIG. 4 shows a snapshot of one downlink frame and one uplink frame for the UE. The uplink transmit timing may be provided by a time tracking loop (TTL), which may be updated by the first detect path and/or other information in each frame. The uplink transmit timing may be constrained such that it can be varied by an amount less than a certain maximum amount in each frame. The slow update speed of the uplink transmit timing may ensure a stable uplink transmit timing for the UE.

The UE may communicate with multiple cells. In this case, the UE may combine received signals from cells whose receive timing at the UE is within the receive window. In particular, Section 7.2.2 of 3GPP TS 25.133 for WCDMA states “a UE shall support reception, demodulation and combining of signals of a downlink DPCH, or a downlink F-DPCH, when the receive timing is within a window of T₀±148 chips before the transmit timing where T₀ is defined in” 3GPP TS 25.211. 3GPP standard may thus require the UE to consider the downlink DPCH or F-DPCH only from cells whose receive timing is within the receive window, which is T₀±148 of the uplink transmit timing. The UE may not be required to consider cells that come later than the receive window.

The receive timing of a cell may dynamically vary by a large amount at the UE. For example, a cell may have its downlink signal retransmitted by a repeater, e.g., as shown in FIG. 1. The UE may receive the downlink signal from the cell as well as a repeated signal from the repeater. The downlink signal and the repeated signal may appear as two multipaths of the same cell to the UE. The repeater may have a relatively long delay, e.g., of more than 200 chips. The receive time of the downlink signal from the cell may then be much earlier than the receive time of the repeated signal from the repeater at the UE. The downlink reference timing may be set based on the first detected path of the cell, which may correspond to the receive time of the downlink signal from cell. The UE may be mobile and may move into an area (e.g., behind a building) in which the UE is not able to receive the downlink signal from the cell but still able to receive the repeated signal from the repeater. The downlink reference timing may then correspond to the receive time of the repeated signal from the repeater. The downlink reference timing may thus dynamically change by a large amount within a short time (e.g., by 220 chips within 10 ms frame). However, the uplink transmit timing may change by a small amount due to the slow update speed of the uplink transmit timing to make it stable.

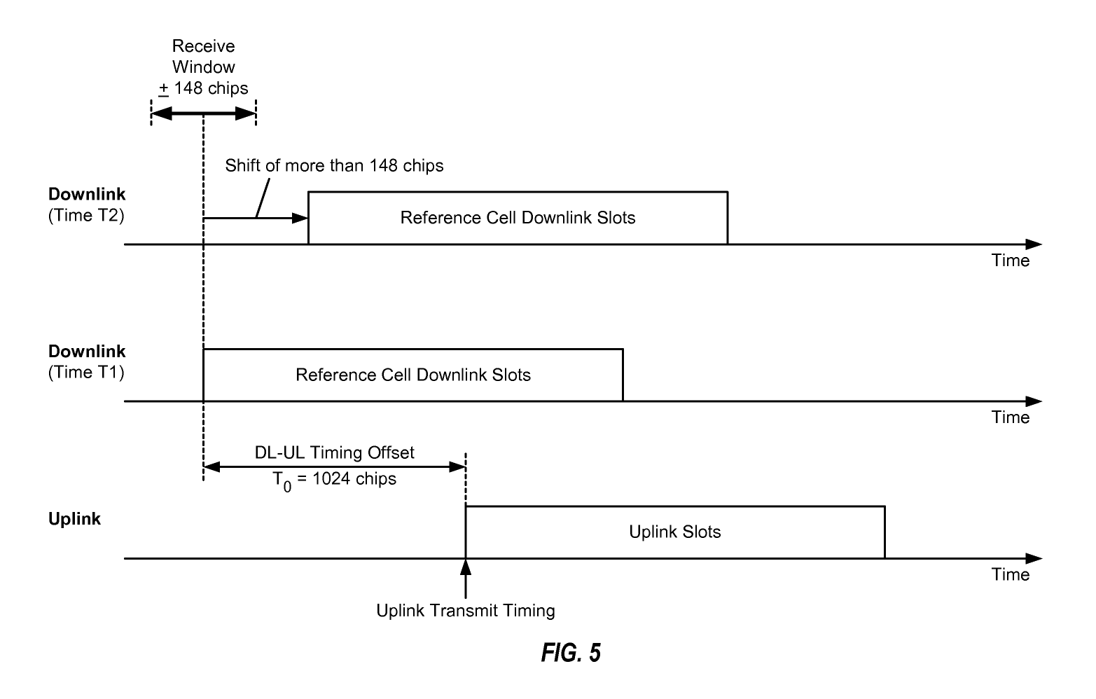

FIG. 5 illustrates the scenario described above. At time T1, the UE may receive the downlink signal from the cell. The downlink reference timing may then correspond to the receive time of the downlink signal from the cell at the UE. At time T2, the UE may receive the repeated signal from the repeater but not the downlink signal from the cell. The downlink reference timing may then correspond to the receive time of the repeated signal from the repeater at the UE. The downlink reference timing may thus move by a large amount (e.g., by more than 148 chips) from time T1 to time T2. The receive time of the repeated signal may be outside of the receive window at time T2.

As shown in FIG. 5, because of the sudden large shift in the downlink reference timing, even though the uplink transmit timing has been adjusted at the maximum rate to track to this shift, the cell may become late relative to the uplink transmit timing, and the receive time of the cell may be outside of the receive window. Consequently, an SIR estimate for the cell may be invalid, and the cell may no longer contribute to downlink power control of the UE. A call between the UE and the cell may be dropped in the case.

In an aspect of the disclosure, the receive window may be dynamically adjusted to capture cells whose receive timing may have suddenly moved by a large amount. Adjustment of the receive window may no longer be limited by adjustment of the uplink transmit timing. Dynamic adjustment of the receive window may include at least the following parts:
Part 1—determine whether to move the receive window by a large amount, i.e., an amount more than an adjustment to the uplink transmit timing, and
Part 2—determine how much to move the receive window.

A window timing may be defined as the time at which the center of the receive window is placed. The window timing may normally be equal to the uplink transmit timing minus T₀ and may be adjusted by the same amount as the uplink transmit timing so that it covers T₀±148 chips before the uplink transmit timing. The window timing may be dynamically adjusted as described below.

In a first aspect of part 1, the receive window may be moved by a large amount if the downlink reference timing has moved by more than a threshold amount. In one aspect, the threshold amount may be equal to 148 chips. In this aspect, the receive window may be moved by a large amount if the downlink reference timing is outside of the receive window at a nominal position of T₀ chips before the uplink transmit timing. The receive window may be initially placed at the nominal position. If the downlink reference timing is within the receive window, then the receive window is not moved by a large amount and may be set to T₀ chips before the uplink transmit timing. Conversely, if the downlink reference timing is outside of the receive window, then the receive window may be moved by a large amount. In general, the threshold amount may be set to any suitable value. For example, the threshold amount may be set to 128 chips or some other value.

For the first aspect of part 1, a determination on whether to move the receive window by a large amount may be expressed as follows:

If absolute {downlink reference timing−uplink transmit timing−T₀}>X chips

Then move receive window by a large amount,

Else move receive window based on a change to uplink transmit timing.

where absolute {z} denotes an absolute value of z, and

X is the threshold amount.

In a second aspect of part 1, the receive window may be moved by a large amount if the receive window placed at the nominal position captures less than a threshold percentage of the total energy of all detected paths at the UE. The threshold percentage may be 50%, 60%, 80%, etc. In this aspect, the energy and receive time/position of each detected path at the UE may be determined. The total energy of all detected paths may be computed. The receive window may be initially placed at the nominal position. If the combined energy of all detected paths within the receive window is less than the threshold percentage of the total energy of all detected paths, then the receive window may be moved by a large amount. Conversely, if the combined energy of all detected paths within the receive window is greater than the threshold percentage of the total energy of all detected paths, then the receive window is not moved by a large amount and may be set to T₀ chips before the uplink transmit timing.

In a third aspect of part 1, the receive window may be moved by a large amount if a weighted receive timing of detected paths of interest is more than a first threshold from the downlink reference timing and is more than a second threshold from the uplink transmit timing. The weighted receive timing may be indicative of an average receive time of detected paths of interest at the UE. The weighted receive timing may account for the energy of each detected path and may be computed as described below. In this aspect, a determination on whether to move the receive window by a large amount may be expressed as follows:

If absolute {weighted receive timing−downlink reference timing}>Y chips

AND absolute {weighted receive timing−uplink transmit timing−T₀}>Z chips

Then move receive window by a large amount,

Else move receive window based on a change in uplink transmit timing.

where Y and Z are two threshold values. In one aspect, Y=Z=128 chips. In other aspects, Y and Z may be set to other suitable values.

In a fourth aspect of part 1, the receive window may be moved based on a window timing defined such that it is not dependent on the uplink transmit timing. In one aspect, the window timing may be defined based on the downlink reference timing. In other aspects, the window timing may be defined based on a center of weight of all detected paths at the UE, or the earliest timing that enables the receive window to capture a certain percentage of the total energy, etc.

Whether to move the receive window by a large amount may also be determined in other manners. Once a determination/decision has been made to move the receive window by a large amount, how much to move the receive window may be determined in various manners.

In a first aspect of part 2, the window timing for the receive window may be set equal to the downlink reference timing when a decision has been made to move the receive window by a large amount. This aspect may enable the receive window to capture a cell whose receive timing has moved by a large amount (e.g., by more than 200 chips) in one frame.

In a second aspect of part 2, the window timing for the receive window may be set based on the weighted receive timing for detected paths of interest when a decision has been made to move the receive window by a large amount. The detected paths of interest may correspond to multipaths tracked by the UE and assigned to fingers of a demodulator at the UE. The detected paths may be for the serving cell and possibly other cells in the active set of the UE. In this aspect, the energy and receive time of each detected path of interest may be determined, e.g., based on the CPICH and/or the dedicated pilot in the downlink DPCH. The weighted receive timing of detected paths of interest may then be computed as follows:

$$weighted receive timing = \frac{{\sum }_{i}^{ } {E}_{i} \cdot {T}_{i}}{{\sum }_{i}^{ } {E}_{i}} , \qquad Eq ( 1 )$$

where Eᵢ is the energy of the i-th detected path, and

Tᵢ is the receive time of the i-th detected path.

As shown in equation (1), the weighted receive timing may be computed as a weighted mean of the receive times of detected paths of interest. The weighted receive timing may be considered as the center of the energy of the detected paths.

The second aspect of part 2 may consider the energy distribution among all detected cells and may enable more energy to be captured by the receive window. For example, the majority of the total energy may come from late cells, and only a small portion of the total energy may be from the reference cell. This aspect may enable the receive window to capture the majority of the total energy and may thus increase system capacity.

In a third aspect of part 2, the window timing for the receive window may be set based on captured energy of detected paths when a decision has been made to move the receive window by a large amount. In this aspect, the energy and receive time/position of each detected path may be determined. The total energy of all detected paths may be computed, and a threshold level may be computed as a target percentage of the total energy. The receive window may be initially placed at the nominal position. The combined energy of all detected paths within the receive window may be computed and compared against the threshold level. If the combined energy is less than the threshold level, then the receive window may be shifted (e.g., later) until it covers another detected path. The combined energy of all detected paths within the receive window may then be computed and compared against the threshold level. If the combined energy is greater than the threshold level, then the receive window may be placed at that position. Otherwise, the process may be repeated, and the receive window may be shifted (e.g., later) until it covers yet another detected path. The process may continue until the window captures at least the target percentage of the total energy. The third aspect may move the receive window by the minimum amount to capture the target percentage of the total energy.

In a fourth aspect of part 2, the window timing for the receive window may be set equal to the receive timing of the strongest detected path at the UE when a decision has been made to move the receive window by a large amount. This aspect may ensure that the strongest detected path is captured by the receive window and used for downlink power control.

The receive window may also be moved by a large amount in other manners. These various aspects may enable the receive window to capture the trend of the downlink energy shift as soon as possible in order to improve downlink capacity. Furthermore, the uplink transmit timing may be updated slowly in the normal manner towards the window timing. Regardless of how the receive window is moved, all cells that fall within the receive window may be considered for downlink power control of the UE.

In general, any combination of aspects for parts 1 and 2 may be used. In a first scheme, which may be referred to as a re-slam downlink receive timing scheme, the first aspects of part 1 may be used with the first aspect of part 2. In this scheme, the receive window may be moved by (i) a large amount if absolute {downlink reference timing—uplink transmit timing—T₀} is more than X chips or (ii) a nominal amount otherwise. If a decision has been made to move the receive window by a large amount, then the window timing may be set equal the downlink reference timing. This scheme can result in the reference cell being considered for downlink power control of the UE even if the cell has moved a large amount. This scheme may also enable the uplink transmit timing to be adjusted slowly in the normal manner toward the downlink reference timing.

In a second scheme, which may be referred to as a weighted receive timing scheme, the third aspect of part 1 may be used with the second aspect of part 2. In this scheme, the receive window may be moved by (i) a large amount if absolute {weighted receive timing—downlink reference timing} is greater than Y chips AND absolute {weighted receive timing—uplink transmit timing—T₀} is greater than Z chips or (ii) a nominal amount otherwise. If a decision has been made to move the receive window by a large amount, then the window timing may be set equal the weighted receive timing computed as shown in equation (1)

The techniques described herein may be used to improve downlink power control. 3GPP standard only mentions the possibility of considering late cells in downlink power control. In particular, 3GPP TS 25.133, Section 7.2.2 states “if the downlink receive timing of one or more cells in the active set is outside the window of T₀±148 chip, the UE may also react with a power adjustment one slot later. The receive timing is defined as the first detected path in time.” The techniques described herein may enable cells whose receive timing has moved by a large amount (e.g., more than 148 chips) to be considered for downlink power control without incurring a one slot delay. This may improve the performance of downlink power control.

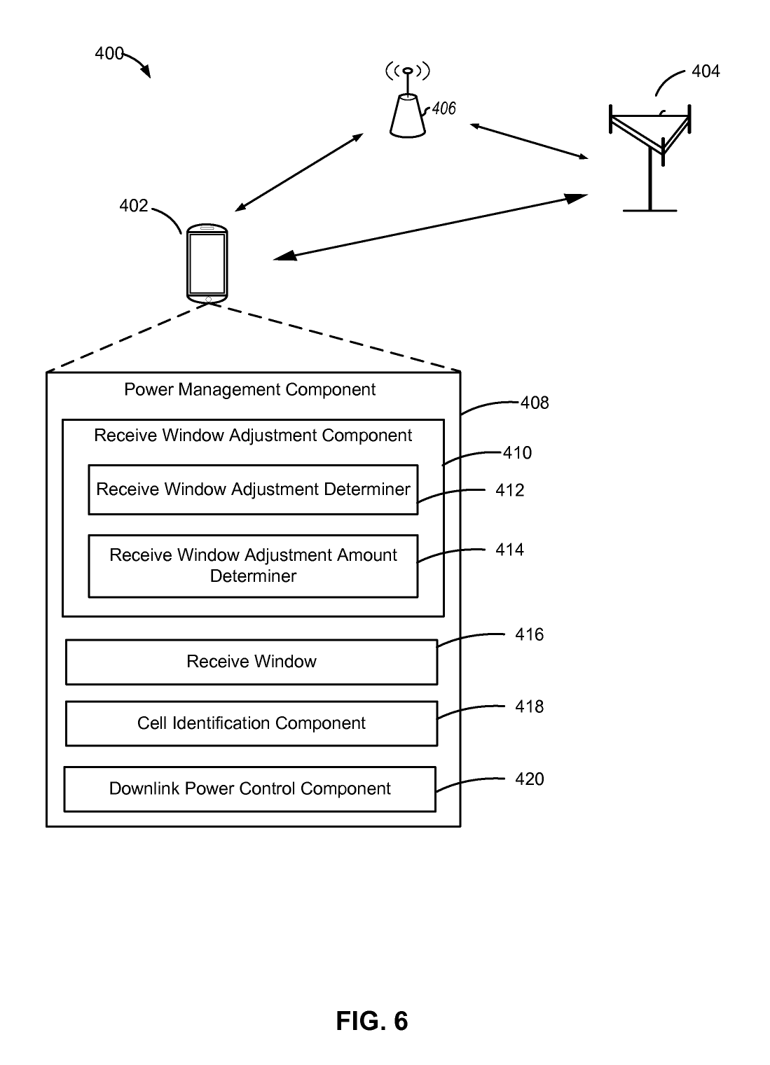

Referring to FIG. 6, in one aspect, a wireless communication system 400 includes a UE 402 for performing power control with dynamic timing updates. The UE 402 may be in communication with one or more repeaters 406 and network entities 404. UE 402 may the same or similar as UE 120 (FIG. 1). Further, network entity 404 may be the same or similar as any one or more Node Bs 110 (FIG. 1). Additionally, repeater 406 may the same or similar as repeater 112 (FIG. 1).

According to the presents, UE 402 may include power management component 408 for performing power control with dynamic timing updates. For example, the power management component 408 may perform various communication power control procedures. In further aspects, power management component 408 may include receive window adjustment component 410, which may be configured to dynamically adjust a receive window 416 to capture cells whose receive timing may have abruptly altered by a large amount. Moreover, receive window adjustment component 410 may include receive window adjustment determiner 412, which may be configured to determine whether to shift the receive window 416 by a particular amount (e.g., an amount larger than an adjustment to the uplink transmit timing). Additionally, in other aspects, receive window adjustment component may include receive window adjustment amount determiner, which may be configured to determine the amount by which to adjust the receive window 416. Other aspects of the power management component 408 may include cell identification component 418, which may be configured to identify at least one cell with receive time within the receive window 416 at the UE 402. Further, power management component 408 may include downlink power control component 420, which may be configured to perform downlink power control for the UE 402 based on the at least one cell.

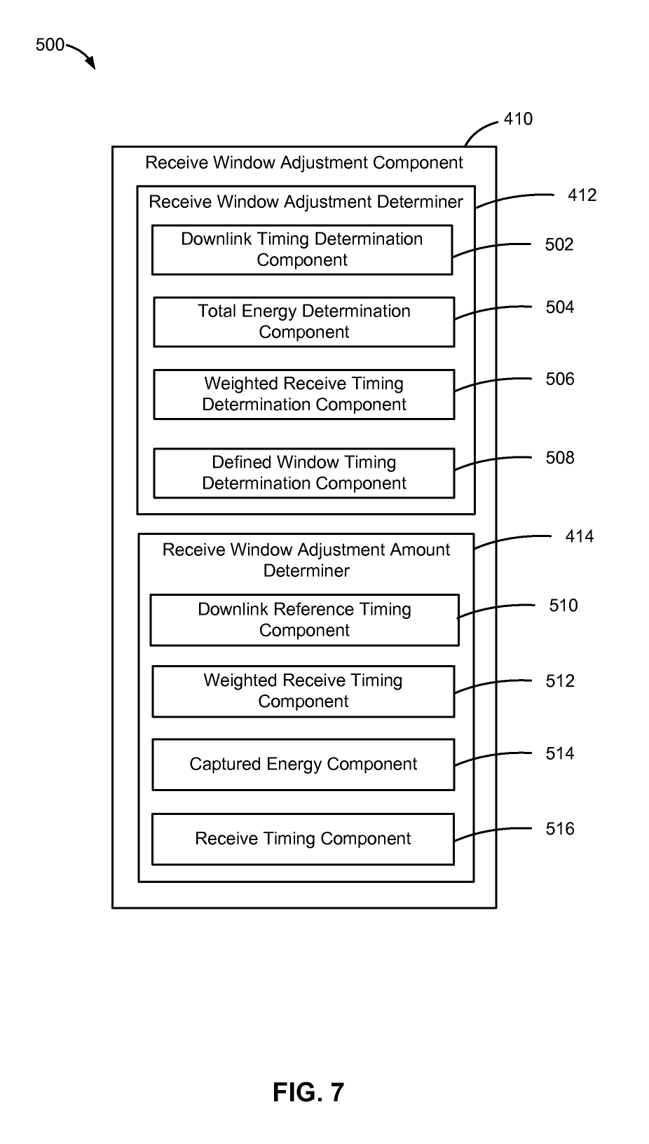

Referring to FIG. 7, in one aspect, the receive window adjustment component 410 may include various subcomponents configured to perform power control with dynamic timing updates. As disclosed herein, receive window adjustment component 410 may include receive window adjustment determiner 502. For example, receive window adjustment determiner 412 may include various subcomponents configured to determine whether to shift the receive window 416 by a particular amount. An aspect of the receive window adjustment determiner 412 may include downlink timing determination component 502, which may be configured to adjust the receive window 416 by a specified amount if the downlink reference timing has moved by more than a threshold value. In one aspect, the threshold amount may be equal to a specified number of chips. Further, receive window adjustment determiner 412 may include total energy determination component 504, which may be configured to adjust the receive window by a specified amount when the receive window 416 placed at the nominal position captures less than a threshold percentage value of the total energy of all detected paths at UE 402. In this aspect, the energy and receive time/position of each detected path at the UE 402 may be determined. For example, if the total energy of all detected paths within the receive window 416 is less than the threshold percentage value of the total energy of all detected paths, then the receive window 416 may be adjusted. Additionally, receive window adjustment determiner 412 may include weighted receive timing determination component 506, which may be configured to adjust the receive window 416 by a specified amount if a weighted receive timing of detected paths of interest is more than a first threshold value from the downlink reference timing and is more than a second threshold value from the uplink transmit timing. For example, the weighted receive timing may be indicative of an average receive time of detected paths of interest at the UE. Moreover, receive window adjustment determiner 412 may include defined window timing determination component 508, which may be configured to determine whether to adjust the receive window 416 based on a window timing defined such that it is not dependent on the uplink transmit timing. It should be understood that the foregoing represents non-limiting cases of receive window 416 adjustment determinations.

Further aspects of the receive window adjustment component 410 may include receive window adjustment amount determiner 414, which may be configured to determine the amount by which to adjust the receive window 416. For example, upon a determination from the receive window adjustment determiner 412 whether to adjust the receive window 416, the receive window adjustment amount determiner 414 may then determine the amount by which to adjust the receive window 416. In one aspect, receive window adjustment amount determiner 414 may include downlink reference timing component 510, which may be configured to set the window timing for the receive window 416 equal to the downlink reference timing when a decision has been made to move the receive window 416 by the receive window adjustment determiner 412. Further, receive window adjustment amount determiner 414 may include weighted receive timing component 512, which may be configured to set the window timing for the receive window based on the weighted receive timing for detected paths of interest when a decision has been made to adjust the receive window 416 by the receive window adjustment determiner 412. Additionally, receive window adjustment amount determiner 414 may include captured energy component 514, which may be configured to set the window timing for the receive window 416 based on captured energy of detected paths when a decision has been made to adjust the receive window by receive window adjustment determiner 412. For example, in the foregoing aspect, the energy and receive time/position of each detected path may be determined. Further, the total energy of all detected paths may be computed, and a threshold level value may be computed as a target percentage of the total energy. The combined energy of all detected paths within the receive window may be computed and compared against the threshold level value. Receive window adjustment amount determiner 414 may also include receive timing component 516, which may be configured to set the window timing for the receive window 416 to the receive timing of the strongest detected path at the UE 402 when a decision has been made to adjust the receive window by the receive window adjustment determiner 412.

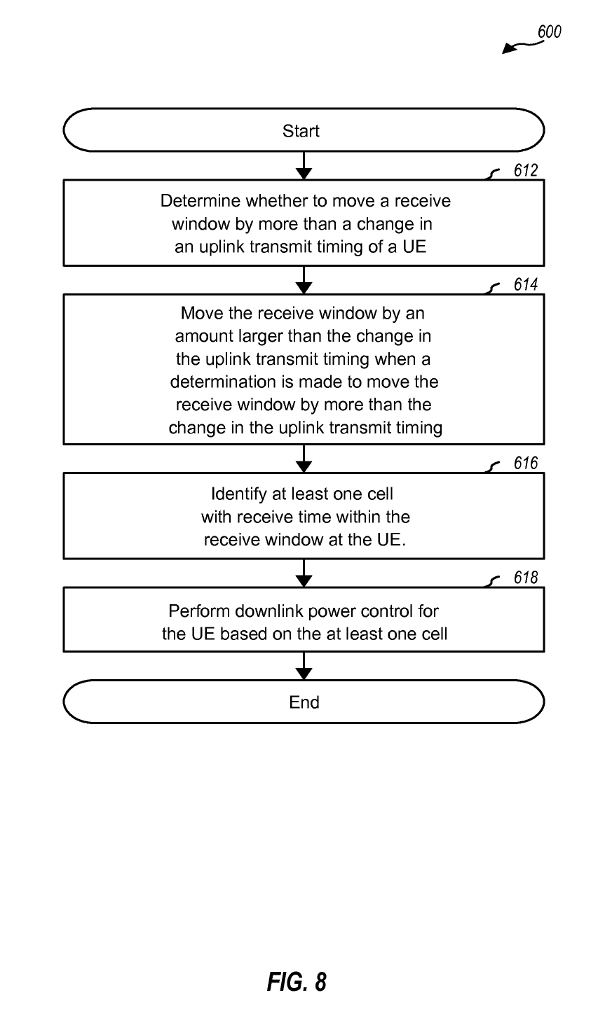

FIG. 8 shows an aspect of a process 600 for performing power control with dynamic timing update. Process 600 may be performed by a UE (as described herein) or by some other entity. The UE may determine whether to move a receive window by more than a change in an uplink transmit timing of the UE (block 612). For example, receive window adjustment component 410 may execute receive window adjustment determiner 412 (FIGS. 6 and 7) to determine whether to adjust a receive window (e.g., receive window 416) by more than a change in an uplink timing of a UE (e.g., UE 402). The UE may move the receive window by an amount larger than the change in the uplink transmit timing (i.e., by a large amount) when a determination is made to move the receive window by more than the change in the uplink transmit timing (block 614). For example, receive window adjustment component 410 may execute receive window adjustment amount determiner 414 (FIGS. 6 and 7) to adjust the receive window (e.g., receive window 416) by an amount greater than the change in the uplink transmit timing when the determination is made to adjust the receive window greater than the change in the uplink transmit timing. The UE may move the receive window by the change in the uplink transmit timing if such a determination is not made. The UE may identify at least one cell with receive time within the receive window at the UE (block 616). For example, power management component 408 may execute cell identification component 418 (FIG. 6) to identify at least one cell with receive time within the receive window (e.g., receive window 416) at the UE (e.g., UE 402). The UE may perform downlink power control based on the at least one cell (block 618). For example, power management component 408 may execute downlink power control component 420 (FIG. 6) to perform downlink power control for the UE (e.g., UE 402) based on the at least one cell.

In block 612, the UE may determine whether to move the receive window by a large amount in various manners. In one aspect, the UE may determine a downlink reference timing based on an earliest detected path of a reference cell at the UE. The UE may determine/decide to move the receive window by more than the change in the uplink transmit timing if a difference between the downlink reference timing and the uplink transmit timing is larger than a threshold value. In another aspect, the UE may determine a combined energy of all detected paths within the receive window moved by the change in the uplink transmit timing, i.e., in the nominal manner. The UE may determine/decide to move the receive window by more than the change in the uplink transmit timing if the combined energy is less than a threshold level. The threshold level may be a certain percentage of the total energy of all detected paths of cells at the UE. In yet another aspect, the UE may determine a weighted receive timing based on energies and receive times of detected paths of cells at the UE. The weighted receive timing may correspond to the center of energy of the detected paths at the UE and may be computed as shown in equation (1). The UE may determine/decide to move the receive window by more than the change in the uplink transmit timing if (i) a difference between the weighted receive timing and the downlink reference timing is larger than a first threshold value and (ii) a difference between the weighted receive timing and the uplink transmit timing is larger than a second threshold value. The UE may also determine whether to move the receive window by a large amount in other manners.

In block 612, the UE may move the receive window by a large amount in various manners. In one aspect, the UE may move the receive window to be centered at the downlink reference timing. In another aspect, the UE may move the receive window to be centered at the weighted receive timing. In yet another aspect, the UE may move the receive window by a minimum amount to capture at least a target amount of energy from all detected paths within the receive window. The target amount of energy may correspond to a certain percentage of the total energy of all detected paths of cells at the UE. In still yet another aspect, the UE may move the receive window to be centered at a receive time of a strongest detected path of a cell at the UE. The UE may also move the receive window by a large amount in other manners.

In one aspect of block 618, the UE may obtain at least one SIR estimate for the at least one cell identified in block 616. The UE may generate at least one TPC command based on the at least one SIR estimate. The UE may send the at least one TPC command to adjust the transmit power of at least one downlink transmission from the at least one cell to the UE. The UE may also perform other actions to support communication based on the at least one cell identified in block 616.

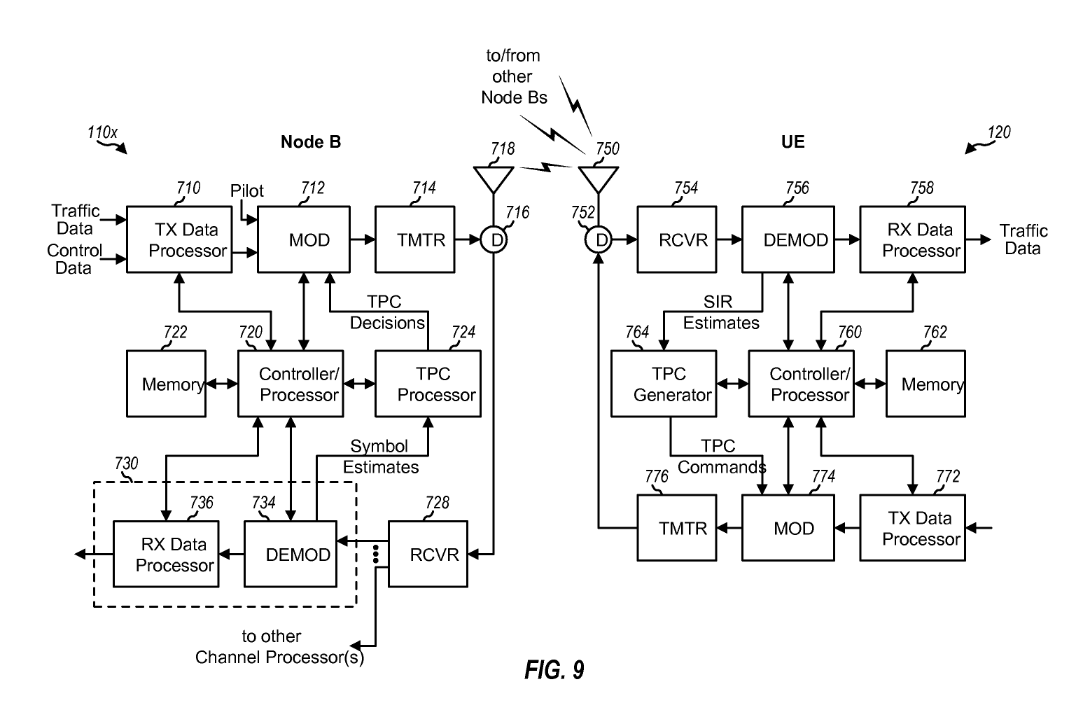

FIG. 9 shows a block diagram of a Node B 110x, which may be one of the Node Bs in FIG. 1 or the network entity 404 (FIG. 6), and UE 120, which may be the same or similar as UE 402 (FIG. 6). At Node B 110x, for the downlink, a transmit (TX) data processor 710 may receive and process (e.g., format, encode, and interleave) traffic data and control data based on one or more coding schemes and provide data symbols. A modulator (MOD) 712 may process the data symbols and pilot symbols and provide complex-valued chips. For WCDMA, the processing by modulator 712 may include (i) channelizing (or “spreading”) each data symbol for each physical channel with an orthogonal variable spreading factor (OVSF) code for that physical channel, (ii) channelizing each pilot symbol with a pilot OVSF code, (iii) combining the channelized data and pilot symbols for all physical channels, and (iv) spectrally spreading (or “scrambling”) the combined symbols with a scrambling sequence assigned to the Node B to obtain the complex-valued chips. A transmitter (TMTR) 714 may condition (e.g., convert to one or more analog signals, amplify, filter, and frequency upconvert) the complex-valued chips to generate a downlink signal, which may be routed through a duplexer 716 and transmitted via an antenna 718 to UEs.

At UE 120, downlink signals from Node B 110x and other Node Bs may be received by an antenna 750, routed through a duplexer 752, and provided to a receiver (RCVR) 754. Receiver 754 may condition (e.g., filter, amplify, and frequency downconvert) the received signal and may further digitize the conditioned signal to obtain input samples. A demodulator (DEMOD) 756, which may be implemented with a rake receiver, may process the input samples to obtain data symbol estimates. For WCDMA, the processing by demodulator 756 may include (i) descrambling the input samples with a descrambling sequence for the Node B being recovered, (ii) channelizing the descrambled samples with OVSF codes to obtain received data symbols and received pilot symbols from their respective physical channels, and (iii) coherently demodulating the received data symbols with pilot estimates to obtain the data symbol estimates. A receive (RX) data processor 758 may decode the data symbol estimates to recover the traffic data and control data sent on the downlink to UE 120.

The processing for an uplink transmission from UE 120 may be performed similarly to that described above for the downlink. The downlink and uplink processing for WCDMA is described in documents 3GPP TS 25.211, 25.212, 25.213, and 25.214, which are publicly available.

For downlink power control, demodulator 756 may derive SIR estimates for cells shows receive timing is within the receive window at UE 120. A TPC generator 764 may receive the SIR estimates from demodulator 756, compare the SIR estimates against the SIR target, and provide TPC commands. The TPC commands may be processed by a modulator 774 and a transmitter 776 and transmitted to Node B 110x and/or other Node Bs. At Node B 110x, an uplink signal from UE 120 may be processed by a receiver 728 and a demodulator 734 to obtain symbol estimates for TPC commands sent by UE 120. A TPC processor 724 may obtain the symbol estimates for the TPC commands and provide TPC decisions, which are estimates of the TPC commands. Modulator 712 may adjust the gain of symbols in a data transmission sent to UE 120 based on the TPC decisions. Demodulator 756 and TPC generator 764 may implement the units for the UE in FIG. 3. TPC processor 724 and modulator 712 may implement the units for the cell in FIG. 3.

Controllers/processors 720 and 760 may direct the operation at Node B 110x and UE 120, respectively. Memories 722 and 762 may store data and codes for controllers/processors 720 and 760, respectively. Controller/processor 760, TPC generator 764, and/or other units at UE 120 may perform process 600 in FIG. 6 and/or other processes for the techniques described herein.

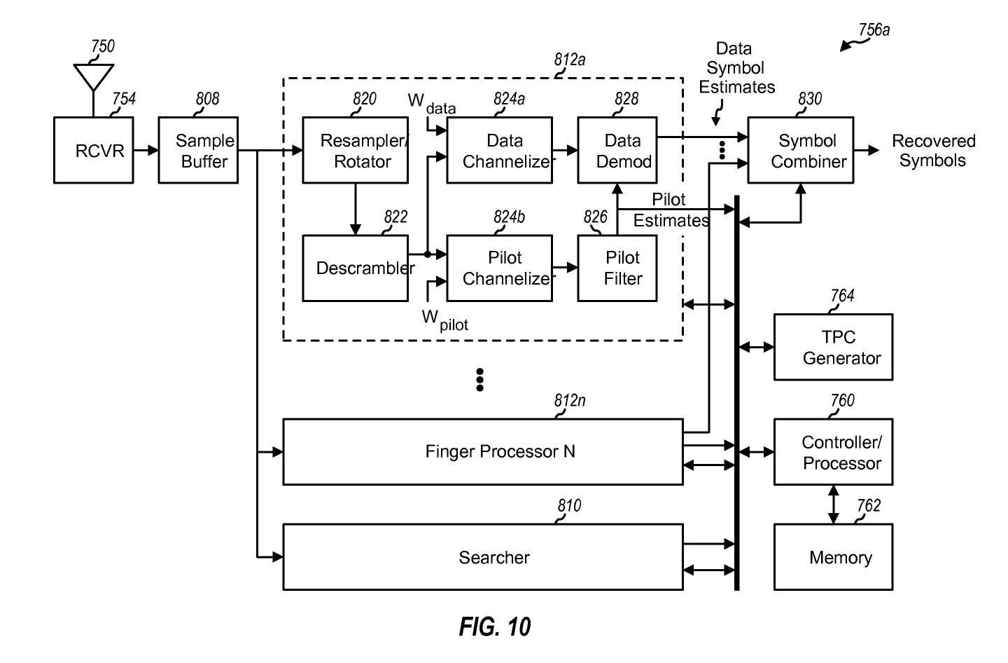

FIG. 10 shows a block diagram of a rake receiver 756a, which is one aspect of demodulator 756 at UE 120 in FIG. 7. Rake receiver 756a includes a sample buffer 808, a searcher 810, N finger processors 812a through 812n, and a symbol combiner 830, where N may be any integer value.

Receiver 754 may process the received signal from antenna 750 and provide input samples, which may be stored in buffer 808. Buffer 808 may thereafter provide the input samples to appropriate processing units (e.g., searcher 810 and/or finger processors 812) at appropriate time. Searcher 810 may search for strong signal instances (or paths) in the received signal and may provide the strength and timing of each detected path that meets a set of criteria. The search processing is known in the art and not described herein.

Each finger processor 812 may be assigned to process a different detected path of interest (e.g., a detected path of sufficient strength). Within each finger processor 812, a resampler/rotator 820 may perform re-sampling and phase rotation on the input samples to obtain de-rotated samples at the proper chip rate and with the proper timing and phase. A descrambler 822 may multiply the de-rotated samples with the descrambling sequence for the Node B being recovered to obtain descrambled samples.

To recover pilot on the CPICH or downlink DPCH, a pilot channelizer 824b may multiply the descrambled samples with the pilot OVSF code, Wₚᵢₗₒₜ, and may accumulate the resultant samples for each time interval Tₚᵢₗₒₜ to obtain a received pilot symbol. Tₚᵢₗₒₜ may be an integer multiple of the length of the pilot OVSF code. A pilot filter 826 may filter the received pilot symbols to obtain pilot estimates for the CPICH or downlink DPCH.

To recover data on the downlink DPCH, a data channelizer 824a may multiply the descrambled samples with an OVSF code, W_{data}, for the downlink DPCH and may accumulate the resultant samples over the length of this OVSF code to obtain received data symbols. A data demodulator 828 may coherently demodulate the received data symbols with the pilot estimates to obtain data symbol estimates. The pilot estimates may be used as phase reference for coherent demodulation.

Symbol combiner 830 may receive and combine data symbol estimates from all finger processors assigned to process each Node B and may provide final data symbol estimates for that Node B. If multiple Node Bs are being processed (e.g., in soft handover), then symbol combiner 830 may provide data symbol estimates for each Node B. Coherent demodulation and symbol combining may be performed as described in U.S. Pat. Nos. 5,764,687 and 5,490,165.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and aspect constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and aspects described herein but is to be accorded the widest scope consistent with the principles and novel features disclosed herein.

What is claimed is:

1. A method for wireless communication, comprising:
determining whether to move a receive window by more than a change in an uplink transmit timing of a user equipment (UE);
moving the receive window by an amount larger than the change in the uplink transmit timing when a determination is made to move the receive window by more than the change in the uplink transmit timing; and
identifying at least one cell with receive time within the receive window at the UE.

2. The method of claim 1, further comprising:
performing downlink power control for the UE based on the at least one cell.

3. The method of claim 2, wherein the performing downlink power control comprises
obtaining at least one signal-to-interference ratio (SIR) estimate for the at least one cell,
generating at least one transmit power control (TPC) command based on the at least one SIR estimate, and
sending the at least one TPC command to adjust transmit power of at least one downlink transmission from the at least one cell to the UE.

4. The method of claim 1, wherein the determining whether to move the receive window by more than the change in the uplink transmit timing comprises
determining a downlink reference timing based on an earliest detected path of a reference cell at the UE, and
determining to move the receive window by more than the change in the uplink transmit timing if a difference between the downlink reference timing and the uplink transmit timing is larger than a threshold value.

5. The method of claim 1, wherein the determining whether to move the receive window by more than the change in the uplink transmit timing comprises
determining a combined energy of all detected paths within the receive window moved by the change in the uplink transmit timing, and
determining to move the receive window by more than the change in the uplink transmit timing if the combined energy is less than a threshold level.

6. The method of claim 1, wherein the determining whether to move the receive window by more than the change in the uplink transmit timing comprises
determining a downlink reference timing based on an earliest detected path of a reference cell at the UE,
determining a weighted receive timing based on energies and receive times of detected paths of cells at the UE, and
determining to move the receive window by more than the change in the uplink transmit timing if a difference between the weighted receive timing and the downlink reference timing is larger than a first threshold value and if a difference between the weighted receive timing and the uplink transmit timing is larger than a second threshold value.

7. The method of claim 1, wherein the moving the receive window comprises
determining a downlink reference timing based on an earliest detected path of a reference cell at the UE, and
moving the receive window to be centered at the downlink reference timing.

8. The method of claim 1, wherein the moving the receive window comprises
determining a weighted receive timing based on energies and receive times of detected paths of cells at the UE, and
moving the receive window to be centered at the weighted receive timing.

9. The method of claim 1, wherein the moving the receive window comprises moving the receive window by a minimum amount to capture at least a target amount of energy from all detected paths within the receive window.

10. The method of claim 1, wherein the moving the receive window comprises moving the receive window to be centered at a receive time of a strongest detected path of a cell at the UE.

11. An apparatus for wireless communication, comprising:
means for determining whether to move a receive window by more than a change in an uplink transmit timing of a user equipment (UE);
means for moving the receive window by an amount larger than the change in the uplink transmit timing when a determination is made to move the receive window by more than the change in the uplink transmit timing; and
means for identifying at least one cell with receive time within the receive window at the UE.

12. The apparatus of claim 11, further comprising:
means for performing downlink power control for the UE based on the at least one cell.

13. The apparatus of claim 12, wherein the means for performing downlink power control comprises
means for obtaining at least one signal-to-interference ratio (SIR) estimate for the at least one cell,
means for generating at least one transmit power control (TPC) command based on the at least one SIR estimate, and
means for sending the at least one TPC command to adjust transmit power of at least one downlink transmission from the at least one cell to the UE.

14. An apparatus for wireless communication, comprising:
at least one processor configured to:
determine whether to move a receive window by more than a change in an uplink transmit timing of a user equipment (UE);
move the receive window by an amount larger than the change in the uplink transmit timing when a determination is made to move the receive window by more than the change in the uplink transmit timing; and
identify at least one cell with receive time within the receive window at the UE.

15. The apparatus of claim 14, wherein the at least one processor is further configured to perform downlink power control for the UE based on the at least one cell.

16. The apparatus of claim 15, wherein to perform downlink power control, the at least one processor is furthered configured to
obtain at least one signal-to-interference ratio (SIR) estimate for the at least one cell,
generate at least one transmit power control (TPC) command based on the at least one SIR estimate, and
send the at least one TPC command to adjust transmit power of at least one downlink transmission from the at least one cell to the UE.

17. The apparatus of claim 14, wherein to determine whether to move the receive window by more than the change in the uplink transmit timing, the at least one processor is further configured to
determine a downlink reference timing based on an earliest detected path of a reference cell at the UE, and
determine to move the receive window by more than the change in the uplink transmit timing if a difference between the downlink reference timing and the uplink transmit timing is larger than a threshold value.

18. The apparatus of claim 14, wherein to determine whether to move the receive window by more than the change in the uplink transmit timing, the at least one processor is further configured to
determine a combined energy of all detected paths within the receive window moved by the change in the uplink transmit timing, and
determine to move the receive window by more than the change in the uplink transmit timing if the combined energy is less than a threshold level.

19. The apparatus of claim 14, wherein to determine whether to move the receive window by more than the change in the uplink transmit timing, the at least one processor is further configured to
determine a downlink reference timing based on an earliest detected path of a reference cell at the UE,
determine a weighted receive timing based on energies and receive times of detected paths of cells at the UE, and
determine to move the receive window by more than the change in the uplink transmit timing if a difference between the weighted receive timing and the downlink reference timing is larger than a first threshold value and if a difference between the weighted receive timing and the uplink transmit timing is larger than a second threshold value.

20. The apparatus of claim 14, wherein to move the receive window, the at least one processor is further configured to
determine a downlink reference timing based on an earliest detected path of a reference cell at the UE, and
move the receive window to be centered at the downlink reference timing.

21. The apparatus of claim 14, wherein to move the receive window, the at least one processor is further configured to
determine a weighted receive timing based on energies and receive times of detected paths of cells at the UE, and
move the receive window to be centered at the weighted receive timing.

22. The apparatus of claim 14, wherein to move the receive window, the at least one processor is further configured to move the receive window by a minimum amount to capture at least a target amount of energy from all detected paths within the receive window.

23. The apparatus of claim 14, wherein to move the receive window, the at least one processor is further configured to move the receive window to be centered at a receive time of a strongest detected path of a cell at the UE.

24. A computer program product, comprising:
a computer-readable medium comprising:
at least one instruction for causing a processor to determine whether to move a receive window by more than a change in an uplink transmit timing of a user equipment (UE);
at least one instruction for causing the processor to move the receive window by an amount larger than the change in the uplink transmit timing when a determination is made to move the receive window by more than the change in the uplink transmit timing; and
at least one instruction for causing the processor to identify at least one cell with receive time within the receive window at the UE.

25. The computer program product of claim 24, further comprising at least one instruction for causing the processor to:
at least one instruction to perform downlink power control for the UE based on the at least one cell.

26. The computer program product of claim 25, wherein the at least one instruction for causing the processor to perform downlink power control comprises
at least one instruction to obtain at least one signal-to-interference ratio (SIR) estimate for the at least one cell,
at least one instruction to generate at least one transmit power control (TPC) command based on the at least one SIR estimate, and
at least one instruction to send the at least one TPC command to adjust transmit power of at least one downlink transmission from the at least one cell to the UE.
